(19) United States
(12) Patent Application Publication
(10) Pub. No.: US 2004/0250712 A1
(43) Pub. Date: Dec. 16, 2004

(54) Process of packaging a compressible article

(76) Inventor: Darold D. Tippey, Neenah, WI (US)

Correspondence Address: SCHWEGMAN, LUNDBERG, WOESSNER & KLUTH, P.A., P.O. BOX 2938, MINNEAPOLIS, MN, 55402, US

(21) Appl. No.: 10/335,198

(22) Filed: Dec. 31, 2002

(51) Int. Cl. B30B 5/00

(52) U.S. Cl. 100/264

(57) ABSTRACT

A process is disclosed which includes applying a variable compression on a compressible article. The compressible article includes an upper zone, a middle zone, and a lower zone. The variable compression is greater at the middle zone that at least one of the upper zone and the lower zone. The process includes placing the compressible article in a flexible container. An apparatus is also disclosed for applying the variable compression on the compressible article. The apparatus includes a press plate with a prominence for compressing the middle zone. A system is also disclosed which includes a plurality of compressible articles in a flexible, plastic container.

### TECHNICAL FIELD

Embodiments relate to a packaged article system. More particularly, embodiments relate to an apparatus for applying a variable compression from a press plate of the apparatus. In particular, a packaged pad is pre-stressed after a manner that causes the flexible package to have a substantially rectangular shape for stacking and display.

### TECHNICAL BACKGROUND

Many articles used as diapers, incontinent products, menstrual pad products, and others are packaged in flexible material. The package is printed with commercial user information, and the package is stacked during storage and transit and for display as a product bag. The process of compressing a pad, followed by inserting the pad into a bag made of flexible packaging material, often results in a bag that forms significantly rounded corners. The significantly rounded corners are caused by the tight packaging material and a higher residual stress at the corners of the bag than any residual strain in the contents of the bag, particularly at the center zone of the contents.

FIG. 1 is a side elevation of a package according to a prior art technique. The package 100 includes a carton 110. The package 100 includes several articles 112 such as disposable diapers which have been inserted into the carton, and the carton 110 has been sealed. The carton 110 is typically made of a cardboard material that is rigid enough to be free standing and to contain several articles 112. The cardboard of the carton 110, however, requires significant processing in order to achieve a commercially acceptable printing surface for retail display. Additionally, the carton 110 is heavy and adds significant weight to the overall commercial product. Another challenge was the bulkiness of the carton 110. Significantly no compression of the articles 112 was workable by use of the carton alone. Consequently, the carton 110 was replaced, by a plastic bag.

With the advent of the plastic bag as a package for compressible articles, processing required a pre-compression of a plurality of articles before their insertion into a plastic bag. The plastic bag allowed for compression of more articles into a smaller space for both storage and product display.

FIG. 2 is a side elevation of a packaging scheme according to conventional technique. FIG. 2 is a side elevation a packaging scheme 200 that includes several compressible articles 212 as they are pressed between two press plates 214. The X-Y-Z orientation depicted in FIG. 2 is in relation to the compressible article 212, which is also a depicts a 90-degree rotational orientation for the compressible articles 112 depicted in FIG. 1.

A conventional press plate system includes substantially planar parallel surfaces of press plates 214, and the press plates 214 contact several compressible articles 212. During packaging, the compressible articles 212 rest upon a surface 216. As the compressible articles 212 rest upon the surface 216, they are pressed between the press plates 214 immediately prior to their insertion into a plastic bag by use of a pusher mechanism (not pictured). The pressure direction is indicated by the opposing arrows 215.

FIG. 3 is a side elevation of a plastic bag 300 that contains a several compressible articles according to conventional technique. FIG. 3 illustrates a plastic bag 318 that is filled with several compressible articles. Although the several compressible articles are not pictured, their orientation is substantially the same as the several compressible articles depicted in FIG. 2. FIG. 3 illustrates a problem that existed in the prior art as the several compressible articles 212 (FIG. 2) were allowed to re-expand within the plastic bag 318. The problem became more pronounced, for example for diapers, when the plastic bag 318 contained about 10 compressible articles. The degree of the problem, however, was dependent upon the dimensional relationship of the compressible articles, their number, and the stress of the plastic bag.

After pressing and inserting the several compressible articles, the plastic bag 318 was sealed and exhibited properties depicted in FIG. 3. The plastic bag 318 includes substantially flat top 320 and bottom 322 surfaces. The plastic bag 318 also includes substantially flat left lateral 324 and right lateral 326 surfaces, respectively. The flat top 320 includes a top surface length 332, and the flat bottom 322 includes a bottom surface length 334 that is typically the same as the top surface length 332 due to symmetry. Similarly, the left lateral surface 324 includes a lateral height 336, and the right lateral surface 326 includes a lateral height 338 that is typically the same as the left surface height 336 due to symmetry.

The plastic bag 318 also includes upper rounded corners 340 with a radius, 342. The plastic bag 318 also includes lower rounded corners 341, also with a radius (not illustrated) that can be similarly defined. For purposes of this discussion, reference is made to the upper rounded corners 340, but the discussion is valid for the lower rounded corners 341.

The radius 342 of the upper rounded corner 340 is defined as the average distance of a scalar as it sweeps between a “flat” upper surface 320 and a “flat” lateral surface such as the left lateral surface 324. The deviation from rectangularity of the plastic bag 318 can be quantified as a function of one of the top surface length 332 and the lateral surface height 336 or 338, and the arc length of the upper rounded corner 340. As the arc length of the upper rounded corner 340 increases relative to the length 332 and height 336 or 338 of the plastic bag 318, the plastic bag 318 becomes unstable as a freestanding article. Similarly, as the arc length of the rounded corner 340 increases relative to the length 332 and height 336 or 338 of the plastic bag 318, the plastic bag 318 becomes less useful for commercial display as the “flat” surfaces are diminished, that otherwise need to carry commercial display information for the consumer.

Reference is again made to FIG. 2. Because of the pre-compression process depicted in FIG. 2, compressive strain in the several compressible articles 212 is substantially uniform in the Y-direction. Once the compressible articles 212 are placed in the bag (FIG. 3), however, the residual strain is disproportionate in the X-direction, when compared at different elevations.

In FIG. 3, qualitative amounts of residual strain are depicted as horizontal vectors. An upper residual strain 344 is depicted as a vector that is resolved between rounded corners 340. At a middle zone, a middle residual strain 346 is depicted as a vector that is resolved substantially in the vertical middle of the plastic bag 318. And at a lower zone, a lower residual strain 348 is depicted as a vector that is resolved between rounded corners 341. The upper residual compressive strain 344 is greater than the middle residual compressive strain 346. Similarly, the lower residual compressive strain 348 is greater than the middle residual compressive strain 346. Depending upon the uniformity of the article to be compressed, the lower residual compressive strain 348 is substantially the same as the upper residual compressive strain 344. The rounded corners 340 and 341 are a result of the disparate residual compressive strains exhibited in the plastic bag 318.

FIG. 4 is a side elevation of two plastic bags that are stacked according to conventional technique. FIG. 4 illustrates a problem with stacking two plastic bags 418 for commercial display and/or for shipping. The two plastic bags 418 are rotated 90 degrees with respect to the plastic bag 318 depicted in FIG. 3, but orientation refers to the several compressible articles depicted in FIG. 2. The rounded corners 440, 441 cause a small footprint of contact for the flat left lateral 424 and right lateral 426 surfaces, respectively. Because of the rounded corners, the stack is less stable for stacking. Stacking the bags 418 with a bottom flat surface 422 against a top flat surface 420 makes the stack more stable than the stack depicted in FIG. 4, but the presence of the rounded corners 440, 441 remains a significant stability problem.

One degree of a departure from rectangularity includes a ratio of the flat stacking surface length, divided by the arc length of the rounded corner. Conventional plastic bags can have a ratio of less than 2 when stacked with a major flat surface. When conventional plastic bags are stacked with a minor flat surface, the ratio can be 1 or less. By this convention, a sphere has a ratio of zero.

What is needed is a packaged article in a bag that forms sufficiently square corners that overcome at least some of the problems of the prior art.

### SUMMARY

A process includes applying a variable compression on a compressible article. The compressible article is pressed at an upper zone, a middle zone, and a lower zone. The process includes applying the variable compression at a greater pressure at the middle zone than at least one of the upper zone and the lower zone. After applying the variable compression, the compressible article is placed in a flexible container.

In one embodiment, the process includes first allowing the compressible article to achieve to a first stasis before inserting it into the flexible container. Thereafter, the process includes allowing the compressible article to achieve a second stasis in the flexible container.

In one embodiment, the process includes forming a rounded corner and a flat surface in the flexible container under conditions to cause the ratio of the flat surface to the arc-length of the rounded corner to be greater than about 2.

One embodiment includes an apparatus. The apparatus includes a press plate for pressing a compressible article through the minor axis of the compressible article. The press plate includes a top zone, a middle zone, and a bottom zone, and the middle zone includes a prominence.

In one embodiment, the press plate includes a cove flange. In one embodiment, the prominence has a profile aspect ratio from about 1,000:1 to about 1:1. In several embodiments, the profile takes on various shapes. For example in one embodiment, the prominence includes a curvilinear profile. In one embodiment, the prominence includes a rectilinear profile. In one embodiment, the prominence includes a multiple-prominence profile. In one embodiment, the prominence includes a stepped profile.

In another embodiment, a system includes a flexible container, a compressible article in the flexible container, and a compressive residual strain in the compressible article. The compressive residual strain exhibits compressive residual strain in an upper zone, a middle zone, and a lower zone, that are substantially equivalent. This substantially equivalent compressive residual strain causes the flexible container to have significantly improved rectangularity.

These and other embodiments are set forth more fully in the balance of the disclosure.

### BRIEF DESCRIPTION OF THE DRAWINGS

In order to understand the manner in which embodiments are obtained, a more particular description of various embodiments briefly described above will be rendered by reference to the appended drawings. Understanding that these drawings depict only typical embodiments that are not necessarily drawn to scale and are not therefore to be considered to be limiting of its scope, the embodiments will be described and explained with additional specificity and detail through the use of the accompanying drawings in which:

FIG. 1 is a side elevation of a packaged article according to conventional technique;

FIG. 2 is a side elevation of a packaging scheme according to conventional technique;

FIG. 3 is a side elevation of a plastic bag that contains a several compressible articles according to conventional technique;

FIG. 4 is a side elevation of two plastic bags that are stacked according to conventional technique;

FIG. 5 is a perspective elevation of a compressible article that is to be packed according to an embodiment;

FIG. 6 is a side elevation of an apparatus and a plurality of compressible articles according to an embodiment;

FIG. 7 is a free-body diagram of the plurality of compressible articles depicted in FIG. 6;

FIG. 8 is a side elevation of a flexible container which contains a plurality of compressible articles according to an embodiment;

FIG. 9 is a side elevation of an apparatus and a plurality of compressible articles according to an embodiment;

FIG. 10 is an elevational cross-section of an apparatus for packaging a plurality of compressible articles according to an embodiment;

FIG. 11 is an elevational cross-section of an apparatus for packaging a plurality of compressible articles according to an embodiment;

FIG. 12 is an elevational cross-section of an apparatus for packaging a plurality of compressible articles according to an embodiment;

FIG. 13 is an elevational cross-section of an apparatus for packaging a plurality of compressible articles according to an embodiment;

FIG. 14 is an elevational cross-section of an apparatus for packaging a plurality of compressible articles according to an embodiment;

FIG. 15 is an elevational cross-section of an apparatus for packaging a plurality of compressible articles according to an embodiment; and

FIG. 16 is a process flow diagram according to an embodiment.

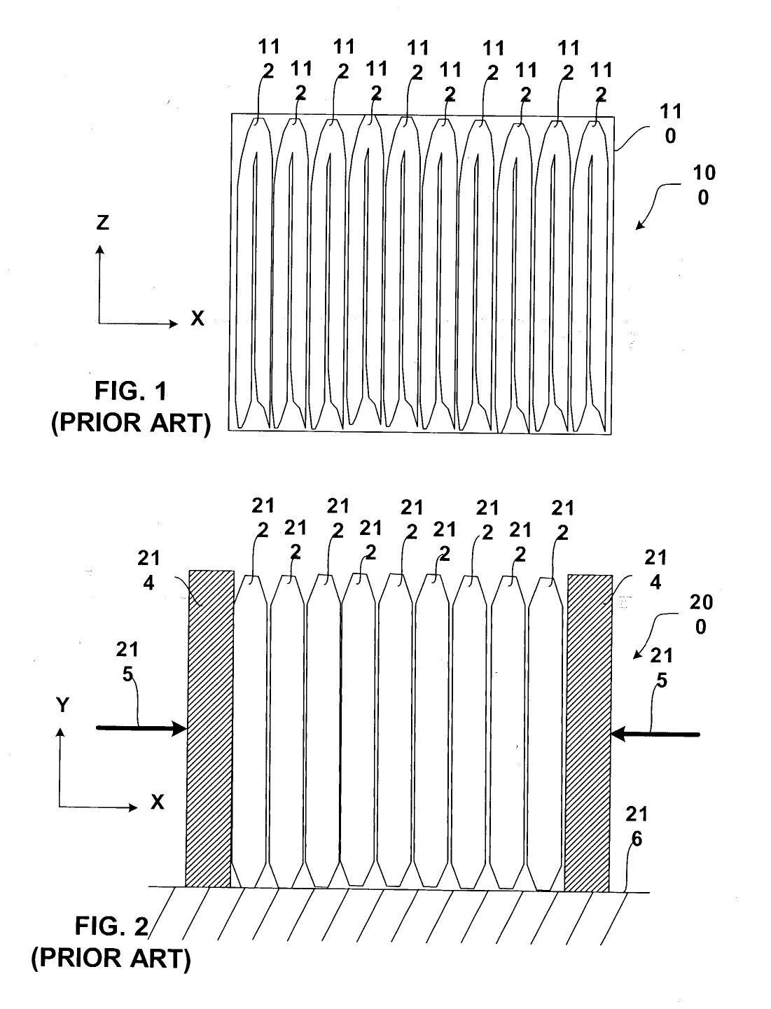

### DETAILED DESCRIPTION

The following description includes terms, such as upper, middle, lower, first, second, etc. that are used for descriptive purposes only and are not to be construed as limiting to orientation, sequence, or number etc. In the following detailed description, reference is made to the accompanying drawings, which form a part hereof. These drawings show, by way of illustration, specific embodiments which may be practiced. In the drawings, some of the like numerals describe substantially similar components throughout the several views. These embodiments are described in sufficient detail to enable those skilled in the art to practice the embodiments. Other embodiments may be used and structural changes may be made without departing from the scope of the several embodiments.

FIG. 5 is a perspective elevation of a compressible article that is processed according to an embodiment. The compressible article 512 is represented as a folded, absorbent article by way of non-limiting example. In one embodiment, the compressible article 512 is an adult care garment or the like, such as for a DEPEND® product or the like, made by Kimberly-Clark Corporation of Neenah, Wis. In one embodiment, the compressible article 512 is a feminine care article or the like, such as for a KOTEX® product or the like, also made by Kimberly Clark Corporation. In one embodiment the compressible article 512 is an infant care garment or the like, such as for a HUGGIES® product or the like also made by Kimberly-Clark Corporation. In one embodiment, the compressible article 512 is a childcare garment or the like, such as for a PULL-UPS® product or the like, also made by Kimberly-Clark Corporation. In one embodiment, the compressible article 512 is a non-woven web or the like, such as for a KLEENEX® product or the like, also made by Kimberly-Clark Corporation.

In one embodiment, the web is a woven web or the like. By reading this disclosure, it becomes clear that another embodiment includes a “compressible article” which is any other material or composite which is conducive to being processed according to the various embodiments set forth in this disclosure. Non-limiting examples of other compressible articles include garments, medical supplies such as bandages, and table napkins. Other non-limiting examples include compressible bulk-packaged items such as are often found a bulk-sale outlets.

The compressible article 512 is depicted as including a major axis 514 that passes through a majority of material. The compressible article 512 is also depicted as including a minor axis 516 that passes through a minimum amount of material. Similarly, the compressible article 112 is also depicted as including a medium axis 118 that passes through an amount of material which is less than the major amount but which is more than the minimum amount. In one embodiment, the compressible article is a folded, absorbent article such as a diaper.

According to an embodiment, compression of the compressible article 512 includes substantial compression in the direction parallel to the minor axis 516, and orthogonal to the plane created by the major axis 514 and the medium axis 518. According to another embodiment, compression of the compressible article 512 includes substantial compression in the direction of one of the major axis 514 and the medium axis 518.

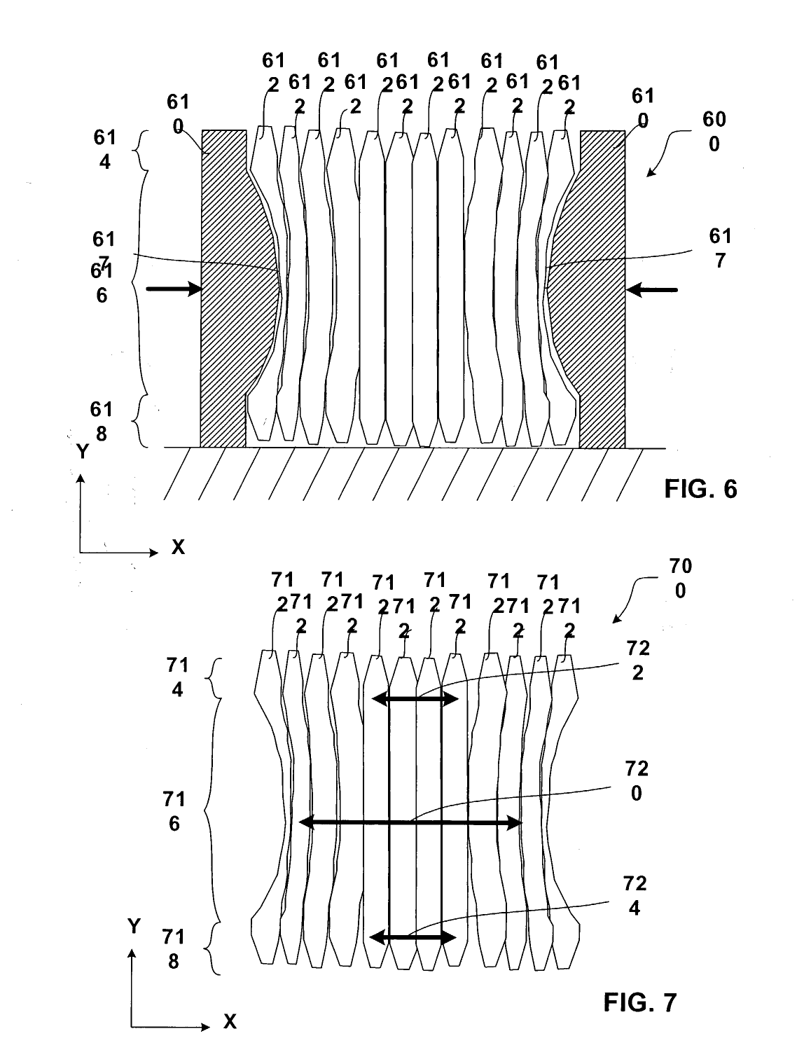

FIG. 6 is a side elevation of an apparatus and a plurality of compressible articles according to an embodiment. The apparatus 600 includes two spaced-apart press plates 610 for pressing a plurality of compressible articles 612 through the minor axis (FIG. 5) of each individual compressible article 612. The X-Y orientation of the plurality of compressible articles 612 indicates the plurality of compressible articles 612 will be pushed in a direction out of the plane of the figure after the compression process.

The two press plates are disposed spaced apart from each other. The press plate 610 includes an upper zone 614, a middle zone 616, and a lower zone 618. The middle zone 616 includes a prominence 617. In one embodiment, a process includes use of the press plate 610. The process includes applying a variable compression from the press plate 610 on the compressible article 612. In one embodiment, the variable compression is greater at the middle zone 616 than at least one of the upper zone 614 and the lower zone 618.

FIG. 7 is a free-body diagram side elevation of a plurality of compressible articles 712 during the process of applying the variable compression to the plurality of compressible articles 612 as depicted in FIG. 6. Three zones of residual strain are depicted qualitatively for each of the upper zone 714, the middle zone 716, and the lower zone 718. FIG. 7 depicts a major residual strain 720 in the middle zone 716, that is resolved to a vector in approximately the center of middle zone 716. FIG. 7 also depicts a first minor residual strain 722, which is resolved to a vector in approximately the center of the upper zone 714. FIG. 7 also depicts a second minor residual strain 724, which is resolved to a vector in approximately the center of the lower zone 718.

As part of a process embodiment, the process includes first allowing the plurality of compressible articles 712 to achieve a first stasis immediately after applying the variable compression. Because the compressible article 712 is resilient, the first stasis is rapidly reached, but the plurality of compressible articles 712 is immediately inserted into a flexible container. A pusher mechanism can be used according to conventional technique. According to the process embodiment, the process continues by second allowing the compressible article to achieve a second stasis while in the flexible container.

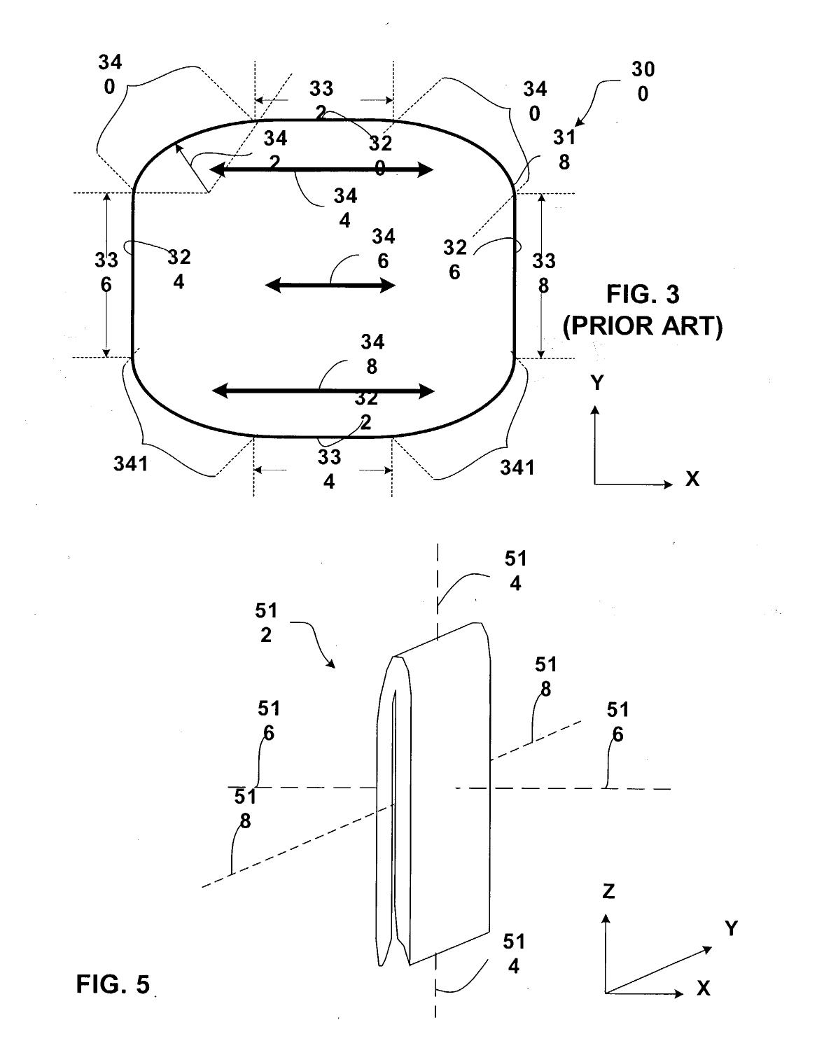

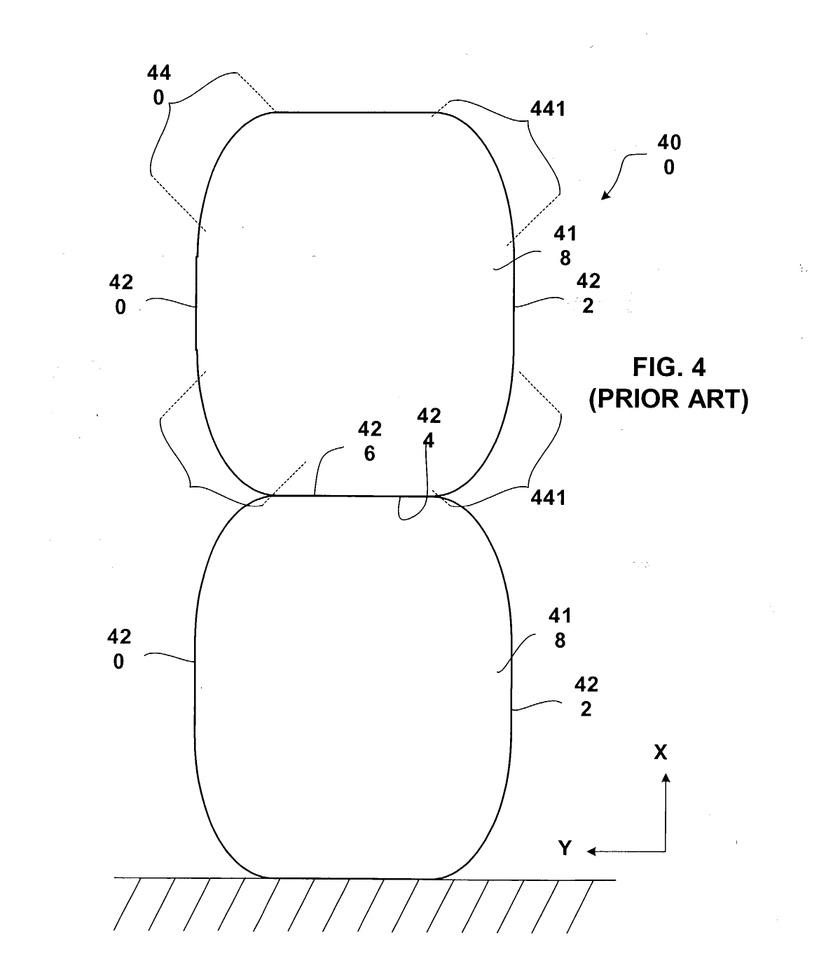

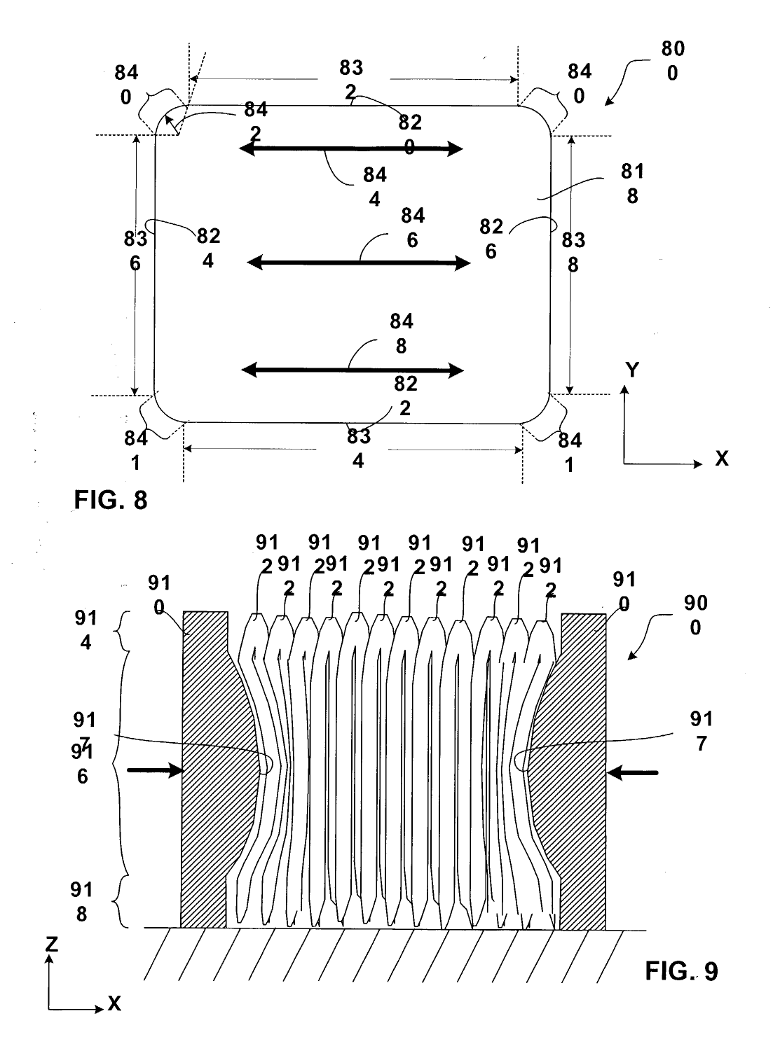

FIG. 8 is a side elevation of a flexible bag that contains a plurality of compressible articles according to an embodiment. The second stasis represents a permanent, long-term state of residual compressive strains within the plurality of compressible articles. FIG. 8 illustrates a flexible bag 818 that is filled with a plurality of compressible articles (not pictured). FIG. 8 illustrates a solution to unacceptably rounded corners in a plastic bag (see FIG. 3) that contained several compressible articles. As mentioned, after variably pressing the plurality of compressible articles, the plurality of compressible articles is inserted into the flexible bag 818 and the flexible bag 818 is sealed.

The flexible bag 818 includes substantially flat top 820 and bottom 822 surfaces, respectively. The flexible bag 810 also includes substantially flat left lateral 824 and right lateral 826 surfaces, respectively. The flat top 820 includes a top surface length 832, and the flat bottom 822 includes a bottom surface length 834 that is typically the same as the top surface length 832 due to symmetry. Similarly, the left lateral surface 824 includes a lateral height 836, and the right lateral surface 826 includes a lateral height 838 that is typically the same as the left surface height 836 due to symmetry.

The flexible bag 818 also includes an upper corner 840 with a radius 842. The flexible bag 818 also includes lower rounded corners 841, also with a radius (not illustrated) that can be similarly defined. For purposes of this discussion, reference is made to the upper rounded corners 840, but the discussion is valid for the lower rounded corners 841.

The radius 842 is defined as the average distance of a scalar as it sweeps between a flat upper surface 832 and a “flat” lateral surface such as the left lateral surface 836. The deviation from rectangularity of the flexible bag 818 can be quantified as a function of the top surface length 832 or the lateral surface height 834, and the arc length of the rounded corner 840. As the arc length of the rounded corner 840 decreases relative to the length and height of the flexible bag 818, the flexible bag 818 becomes more stable as a free-standing article. Similarly, as the arc length of the rounded corner 840 decreases relative to the length and height of the flexible bag 818, the flexible bag 318 becomes more useful for commercial display because the “flat” surfaces are enlarged, that carry commercial display information for the consumer.

Because of the process of applying the variable compression to the plurality of compressible articles, followed by insertion of the plurality of compressible articles into the flexible bag 818, a substantially constant residual compressive strain is exhibited in the Z-direction in the plurality of compressible articles. In FIG. 8, qualitative amounts of residual compressive strain are depicted as two-dimensional vectors. At an upper zone, the upper residual compressive strain 844 is substantially the same as the middle residual compressive strain 846 in a middle zone. Depending upon the uniformity of the article to be compressed, the lower residual compressive strain 848 at a lower zone is also substantially the same as the upper residual compressive strain 844 in the upper zone.

The respective upper and lower residual compressive strains 844 and 848, are due to the corners 840 and 841 of the flexible bag 818 as they squeeze the plurality of compressible articles (not pictured). The middle residual compressive strain 846 is due to the process of applying the variable compression on the plurality of compressible articles. In any event, the corners 840 and 841 are such that a substantially constant residual compressive strain is exhibited in the Z-direction within the plurality of compressible articles. As depicted in FIG. 8, the substantially constant residual compressive strain is resolved for illustrative purposes as an upper residual compressive strains 844, a middle residual compressive strain 846, and a lower residual compressive strain 848.

In one embodiment the middle residual compressive strain 720 depicted in FIG. 7 is substantially the same middle residual compressive strain 846 depicted in FIG. 8, after the plurality of compressible articles 712 have been inserted into the flexible bag 818. The second stasis is therefore depicted in FIG. 8, such that the upper residual compressive strain 844, the middle residual compressive strain 846, and the lower residual compressive strain 848 are substantially the same. In one embodiment, the second stasis represents residual compressive strains that are within about 50 percent of each other, particularly the middle residual compressive strain 846, and at least one of the upper residual compressive strain 844, and the lower residual compressive strain 848. In one embodiment, the second stasis represents residual compressive strains that are within about 10 percent of each other.

In one embodiment, whether the sum of the residual compressive strains is substantially equal within the flexible bag 818, is secondary to the fact that the plurality of compressible articles 712 has been compressed according to an embodiment, and thereafter, the rectangularity of the flexible bag 818 exists in equilibrium with its contents, and an analysis of the residual compressive strains is not of primary concern. In other words, the process embodiments achieve a rectangular flexible bag 818 embodiment.

In one embodiment, the degree of a departure from rectangularity for the flexible bag 818 includes a ratio of the stacking flat surface length, divided by the arc length of the rounded corner 840. By this convention, a sphere has a ratio of zero. In one embodiment, the bag has a ratio greater than about 10 when stacked with a major flat surface such as the flat top 820 and bottom 822 surfaces. In one embodiment, the bag has a ratio greater than about 2 when stacked with a minor flat surface such as the flat left lateral 824 and right lateral 826 surfaces.

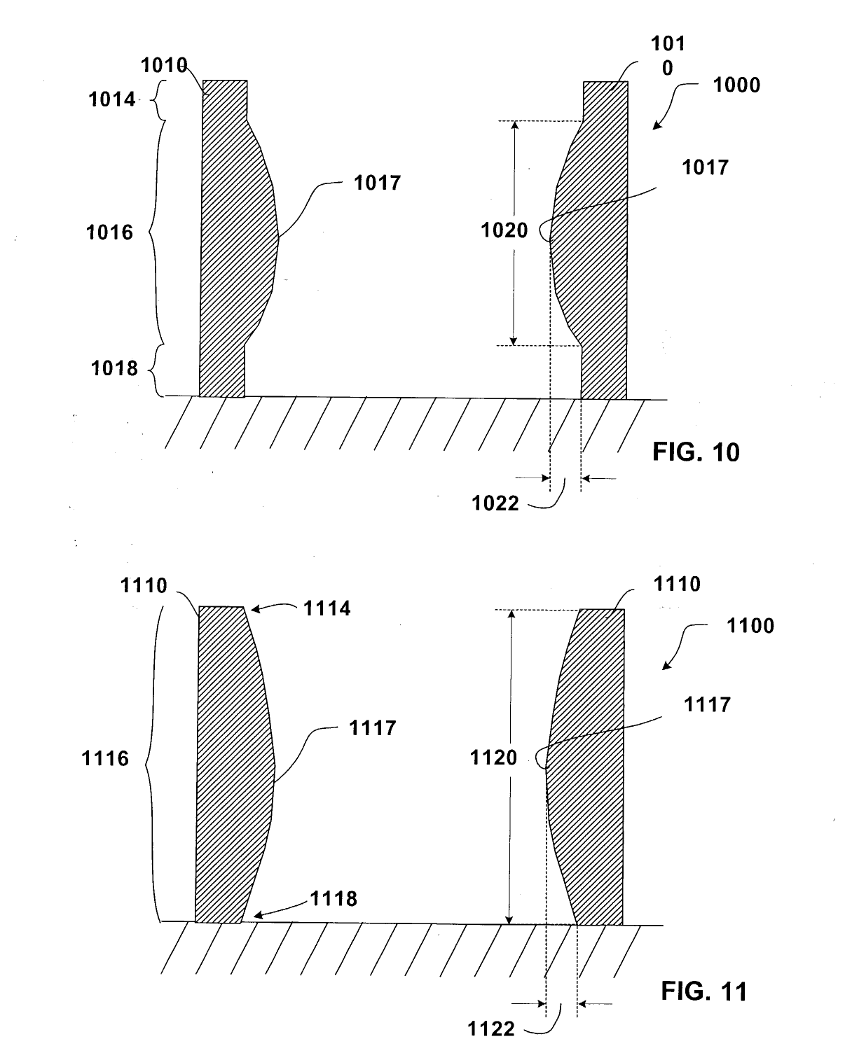

According to various embodiments, the process of applying a variable compression on a compressible article can depend upon the article that is being compressed. Additionally, the variable compression itself can be changed to meet a given application. The following non-limiting embodiments depicted in FIGS. 9-15 are illustrative of various embodiments. The specific shapes given are non limiting, and specific shapes can be dictated by specific compressible articles.

FIG. 9 is a side elevation of an apparatus and a plurality of compressible articles according to an embodiment. The apparatus 900 includes two spaced-apart press plates 910 for pressing a plurality of compressible articles 912 through the minor axis (FIG. 5) of each individual compressible article 912. The X-Z orientation of the plurality of compressible articles 912 indicates the plurality of compressible articles 912 will be pushed in a direction out of the plane of the figure after the compression process.

The two press plates are disposed spaced apart from each other. The press plate 910 includes an upper zone 914, a middle zone 916, and a lower zone 918. The middle zone 916 includes a prominence 917. In one embodiment, a process includes use of the press plate 910. The process includes applying a variable compression from the press plate 910 on the compressible article 912. In one embodiment, the variable compression is greater at the middle zone 916 that at least one of the upper zone 914 and the lower zone 918.

By reading this disclosure, it should be clear to one of ordinary skill in the art that the embodiments depicted in FIGS. 6 and 9 are combinable into another embodiment. In this embodiment, a variable compression is applied to the geometric center or a center region of the compressible article, in two dimensions.

FIG. 10 is an elevational cross-section of an apparatus for packaging a plurality of compressible articles according to an embodiment. The apparatus 1000 includes two spaced-apart press plates 1010 for pressing a plurality of compressible articles through the minor axis (FIG. 5) of each individual compressible article. The press plate 1010 includes an upper zone 1014, a middle zone 1016, and a lower zone 1018. The middle zone 1016 includes a prominence 1017.

In one embodiment, the prominence 1017 has a substantially semi-circular vertical profile. In one embodiment, the prominence 1017 has an arbitrary convex curvilinear shape that includes no inflection point in the curvilinear shape. In any event, the prominence 1017 can be shape-quantified by description of an aspect ratio. The aspect ratio is defined as the prominence height 1020, divided by the prominence width 1022. In one embodiment, the aspect ratio is in a range from about 1,000:1 to about 1:1. In one embodiment, the aspect ratio is in a range from about 100:1 to about 10:1. In one embodiment, the aspect ratio is in a range from about 5:1 to about 2:1.

FIG. 11 is an elevational cross-section of an apparatus for packaging a plurality of compressible articles according to an embodiment. The apparatus 1100 includes two spaced-apart press plates 1110 for pressing a plurality of compressible articles through the minor axis (FIG. 5) of each individual compressible article. The press plate 1110 includes an upper zone 1114, a middle zone 1116, and a lower zone 1118. The middle zone 1116 includes a prominence 1117. In this embodiment, the prominence 1117 occupies a position on the press plate 1110 such that size of the upper zone 1114 and the lower zone 1118, or one of them, shrinks to about zero. In other words, where one of the upper zone 1114 or the lower zone 1118 shrinks to about zero. Such a zone is merely the boundary of the press plate 1110, with no substantially vertical portion of the press plate 1110.

Similar to the embodiment depicted in FIG. 10, one embodiment includes the prominence 1117 with a substantially semi-circular vertical profile. In one embodiment, the prominence 1117 has an arbitrary curvilinear shape that includes no inflection point in the curvilinear shape. In any event, the prominence 1118 can be shape-quantified by description of an aspect ratio. The aspect ratio is defined as the prominence height 1120, divided by the prominence width 1122. In one embodiment, the aspect ratio is in a range from about 1,000:1 to about 1:1. In one embodiment, the aspect ratio is in a range from about 100:1 to about 10:1. In one embodiment, the aspect ratio is in a range from about 5:1 to about 2:1.

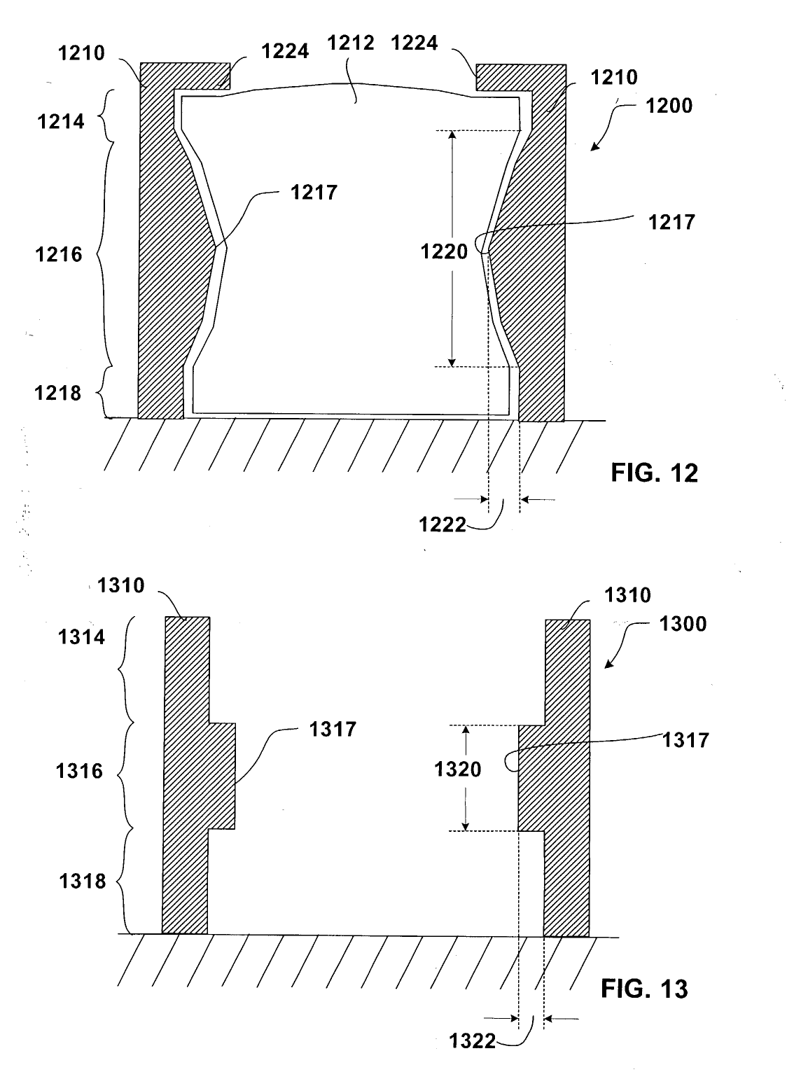

FIG. 12 is an elevational cross-section of an apparatus for packaging a plurality of compressible articles according to an embodiment. The apparatus 1200 includes two spaced-apart press plates 1210 for pressing a plurality of compressible articles through the minor axis (FIG. 5) of each individual compressible article. The press plate 1210 includes an upper zone 1214, a middle zone 1216, and a lower zone 1218. The middle zone 1216 includes a prominence 1217. As in other embodiments, the prominence 1217 includes an aspect ratio which is defined as the prominence height 1220 divided by the prominence width 1222.

Additionally the press plate 1210 includes a cove flange 1224. In one embodiment, the cove flange 1224 is included for the functionality of improved securing of a plurality of compressible articles 1112 during the process of applying a variable compression on the compressible articles. In FIG. 12, the plurality of compressible articles 1212 is depicted in approximate outline during the process of applying a variable compression.

The lateral extent of the cove flange 1224 can be dictated by the degree of compression which is desired to be achieved during processing. In one embodiment for about 10 diapers, closure of two spaced-apart cove flanges 1224 is about one-half inch from total closure. In one embodiment for about 10 diapers, total closure is achieved for the two spaced-apart cove flanges 1224. These embodiments, however are not to be construed as limiting, and the amount of the lateral extension of the cove flange 1224 to the aspect ratio of the prominence 1217 are not necessarily to the scale depicted in FIG. 12.

It can now be appreciated that the embodiments of substantially zero-dimensioned upper and lower zones, or one of them, are applicable to the various embodiments depicted in FIGS. 6, and 9-15. It can also now be appreciated that the embodiments of a cove flange are applicable to the various embodiments depicted in FIGS. 2, 6, and 9-15. Where the cove flange (FIG. 12) is applicable to a substantially conventional press plate, such as the press plate depicted in FIG. 2, the press plate can include an aspect ratio of the prominence in a range from about 100:1 to about 1,000:1, or it can be substantially planar.

FIG. 13 is an elevational cross-section of an apparatus for packaging a plurality of compressible articles according to an embodiment. The apparatus 1300 includes two spaced-apart press plates 1310 for pressing a plurality of compressible articles through the minor axis (FIG. 5) of each individual compressible article. The press plate 1310 includes an upper zone 1314, a middle zone 1316, and a lower zone 1318. The middle zone 1316 includes a prominence 1317.

The prominence 1317 includes a substantially rectilinear vertical profile. The prominence 1317 can be shape-quantified by description of an aspect ratio. The aspect ratio is defined as the prominence height 1320, divided by the prominence width 1322. In one embodiment, the aspect ratio is in a range from about 1,000:1 to about 1:1. In one embodiment, the aspect ratio is in a range from about 100:1 to about 10:1. In one embodiment, the aspect ratio is in a range from about 5:1 to about 2:1. In one embodiment, the prominence 1317 has smoothed corners to protect the compressible articles being processed.

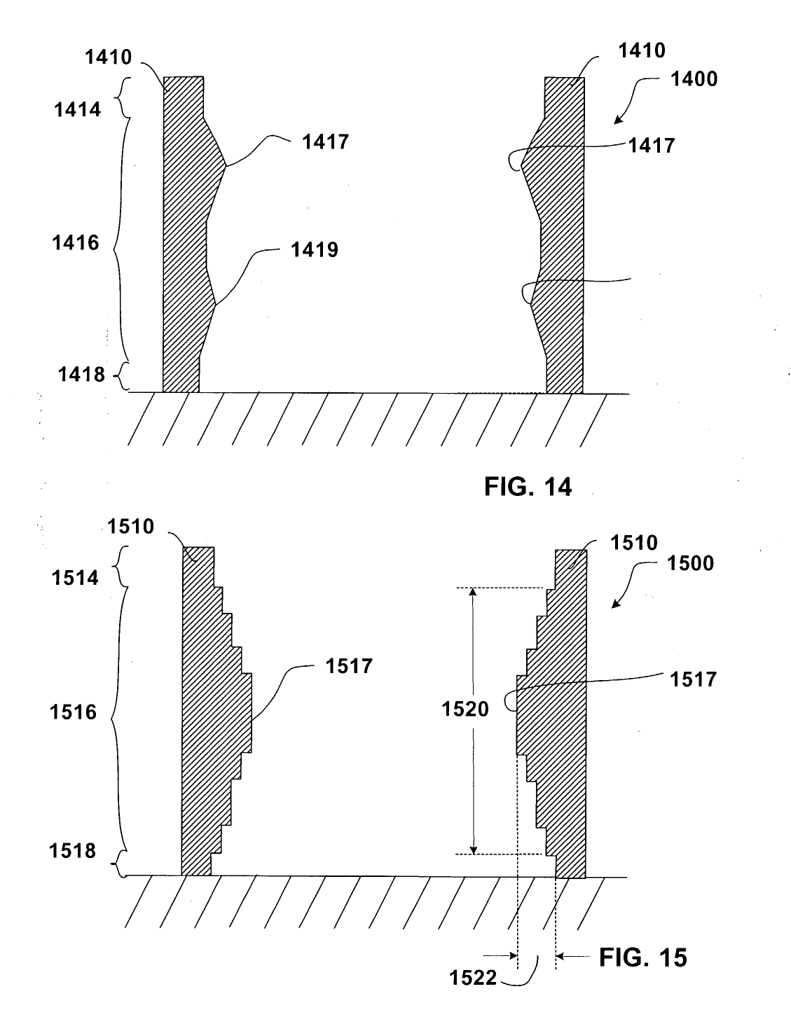

FIG. 14 is an elevational cross-section of an apparatus for packaging a plurality of compressible articles according to an embodiment. The apparatus 1400 includes two spaced-apart press plates 1410 for pressing a plurality of compressible articles through the minor axis (FIG. 5) of each individual compressible article. The press plate 1410 includes an upper zone 1414, a middle zone 1416, and a lower zone 1418. The middle zone 1416 includes a prominence.

In this embodiment, the prominence has a customized, multiple-prominence vertical profile. In one embodiment, the prominence has an arbitrary curvilinear shape that includes a major prominence 1417 and a minor prominence 1419. As customized, the multiple-prominence vertical profile is applicable for the process of packaging a plurality of compressible articles that include thicknesses and/or structures, as compressible through the minor axis (FIG. 5) that are variable when examined in one of the Y-dimension or the Z-dimension.

In any event, the multiple-prominence profile can be shape-quantified by description of an aspect ratio, whether overall or for one of the major or minor prominences, according to the various aspect ratio embodiments set forth herein for other embodiments.

FIG. 15 is an elevational cross-section of an apparatus for packaging a plurality of compressible articles according to an embodiment. The apparatus 1500 includes two spaced-apart press plates 1510 for pressing a plurality of compressible articles through the minor axis (FIG. 5) of each individual compressible article. The press plate 1510 includes an upper zone 1514, a middle zone 1516, and a lower zone 1518. The middle zone 1516 includes a prominence 1517.

In one embodiment, the prominence 1517 is achieved by a discrete, incremented profile. In one embodiment, the prominence 1517 has an arbitrary incremented rectilinear shape that includes a back-to-back staircase appearance. In any event, the prominence 1517 can be shape-quantified by description of an aspect ratio. The aspect ratio is defined as the prominence height 1520, divided by the prominence width 1522. In one embodiment, the aspect ratio is in a range from about 1,000:1 to about 1:1. In one embodiment, the aspect ratio is in a range from about 100:1 to about 10:1. In one embodiment, the aspect ratio is in a range from about 5:1 to about 2:1.

In one embodiment, the aspect ratio of the prominence 1517 is adjustable by configuring the prominence 1517 as discrete, horizontally adjustable sections of the press plate 1510 which make up the stepped structure. In other words, each discrete portion of the prominence 1517 is individually adjustable for the press plate 1510. In one embodiment, the prominence 1017 in FIG. 10 is approximated by a plurality of discrete pieces such as is depicted in FIG. 15. In one embodiment, the number of discrete pieces is increased until substantially no difference is detectable during processing, between an “analog” prominence 1017 in FIG. 10, and a “digital” prominence 1517 in FIG. 15. In one embodiment, the individually adjustable portions of the prominence 1517 are screw-mounted and adjustable. In one embodiment, the individually adjustable portions of the prominence 1517 are channel-and-clamp mounted and adjustable.

It should be clear by reading this disclosure, that an adjustable prominence embodiment such as is depicted in FIG. 15 and supporting text, is useful in approximating all other prominences depicted in FIGS. 2, 6, and 9-14. In one embodiment, the press plate is substantially planar, and the “prominence” is likewise substantially non-existent, but the press plate includes a plurality of adjustable pieces that make up the upper zone, the middle zone, and the lower zone.

It should also be clear by reading this disclosure that the plurality of discrete pieces such as is depicted in FIG. 15, can include curvilinear discrete pieces, in combination with other curvilinear discrete pieces, or rectilinear discrete pieces.

It should also be clear by reading this disclosure that one embodiment includes a single press plate with a prominence which is spaced apart from a press plate with substantially no prominence. The single press plate with a prominence can include any of the disclosed prominences and their equivalents.

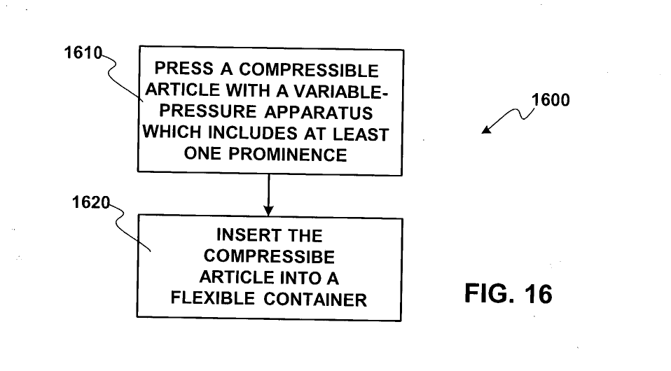

FIG. 16 is a process flow diagram according to an embodiment. The process 1600 includes pressing a compressible article by a variable-pressure press plate, and inserting the compressible article into a flexible bag.

At 1610, a compressible article is compressed with a press plate that includes an adjustable vertical profile. The adjustable vertical profile includes at least one prominence.

At 1620, the process continues by inserting the compressible article into a flexible bag. The compressible article carries with it a residual strain that was incurred during compressing.

By reading the disclosure, it becomes clear that other processes of applying a variable pressure to a plurality of compressible articles can be done by apparatus different from a press plate. For example, the plurality of compressible articles can be fed to a roller apparatus that imparts a variable pressure according to one of the several disclosed embodiments, followed by inserting of the plurality of compressible articles into a flexible container.

It is emphasized that the Abstract is provided to comply with 37 C.F.R. § 1.72(b) requiring an Abstract that will allow the reader to quickly ascertain the nature and gist of the technical disclosure. It is submitted with the understanding that it will not be used to interpret or limit the scope or meaning of the claims

In the foregoing Detailed Description, various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the Detailed Description of Embodiments of the Invention, with each claim standing on its own as a separate preferred embodiment

It will be readily understood to those skilled in the art that various other changes in the details, material, and arrangements of the parts and processes which have been described and illustrated in order to explain the nature of this invention may be made without departing from the principles and scope of the invention as expressed in the subjoined claims.

1. A process comprising:
applying a variable compression on a compressible article, wherein the compressible article includes an upper zone, a middle zone, and a lower zone, and wherein the variable compression is greater at the middle zone than at least one of the upper zone and the lower zone; and
placing the compressible article in a flexible container.

2. The process according to claim 1, before placing the compressible article into a flexible container, the process further including:
first allowing the compressible article to achieve to a first stasis; and thereafter
in the flexible container, second allowing the compressible article to achieve a second stasis.

3. The process according to claim 1, wherein placing the compressible article in a flexible container includes forming a rounded corner and a flat surface in the flexible container, and wherein after placing the compressible article into a flexible container, the ratio of the flat surface to the arc-length of the rounded corner is greater than about 2.

4. The process according to claim 1, wherein applying a variable compression on a compressible article includes a applying a variable compression to a plurality of compressible articles, selected from a folded article, a folded absorbent article, an adult care garment, a feminine care article, an infant care garment, a childcare garment, and a non-woven web.

5. The process according to claim 1, wherein applying a variable compression includes applying a variable compression to a plurality of contiguous compressible articles.

6. The process according to claim 1, wherein applying a variable compression includes employing a press plate including a cove flange.

7. The process according to claim 1, wherein applying a variable compression includes the prominence including an aspect ratio from about 1,000:1 to about 1:1.

8. The process according to claim 1, wherein applying a variable compression includes employing a press plate including a curvilinear vertical profile.

9. The process according to claim 1, wherein applying a variable compression includes employing a press plate including a rectilinear vertical profile.

10. The process according to claim 1, wherein applying a variable compression includes employing a press plate including a multiple-prominence vertical profile, and wherein at least one prominence of the multiple-prominence vertical profile has an aspect ratio from about 1,000:1 to about 1:1.

11. An apparatus comprising:
a press plate for pressing a compressible article, wherein the press plate includes a top zone, a middle zone, and a bottom zone, and wherein the middle zone is capable of exhibiting a prominence.

12. The apparatus according to claim 11, wherein the press plate is for pressing the compressible article through the minor axis of the compressible article.

13. The apparatus according to claim 11, wherein the press plate includes a cove flange.

14. The apparatus according to claim 11, wherein the prominence has a profile aspect ratio from about 1,000:1 to about 1:1.

15. The apparatus according to claim 11, wherein the prominence includes a curvilinear profile.

16. The apparatus according to claim 11, wherein the prominence includes a rectilinear profile.

17. The apparatus according to claim 11, wherein the prominence includes a multiple-prominence profile, and wherein at least one prominence of the multiple-prominence profile has an aspect ratio from about 1,000:1 to about 1:1.

18. The apparatus according to claim 11, wherein the prominence includes a stepped profile.

19. The apparatus according to claim 11, wherein the prominence is discretely adjustable.

20-24. (Cancelled).

25. A process comprising:
applying a variable compression on a compressible article, wherein the compressible article includes an upper zone, a middle zone, and a lower zone, and wherein the variable compression is greater at the middle zone than at least one of the upper zone and the lower zone;
first allowing the compressible article to achieve to a first stasis;
placing the compressible articles in a flexible container; and
second allowing the compressible article to achieve a second stasis, wherein placing the compressible article in a flexible container includes forming a rounded corner and a flat surface in the flexible container, and wherein after placing the compressible article into a flexible container, the ratio of the flat surface to the arc-length of the rounded corner is greater than about 2.

26. The process of claim 25, wherein applying a variable compression includes applying a variable compression to a plurality of contiguous compressible articles.

27. The process of claim 25, wherein applying a variable compression includes employing a press plate including a cove flange.

28. The process of claim 25, wherein applying a variable compression includes employing a press plate including a prominence including an aspect ratio from about 1,000:1 to about 1:1.

29. The process of claim 25, wherein applying a variable compression includes employing a press plate including a vertical profile selected from curvilinear, rectilinear, and multiple-prominence.
